(19) United States
(12) Patent Application Publication
(10) Pub. No.: US 2024/0249074 A1
(43) Pub. Date: Jul. 25, 2024

(54) METHOD FOR GENERATING KEYWORD FOR SOUND SOURCE

(71) Applicant: CASTU Co., Ltd., Chungcheongnam-do (KR)

(72) Inventor: Se Han JIN, Gangwon-do (KR)

(73) Assignee: CASTU Co., Ltd., Asan-si, Chungcheongnam-do (KR)

(21) Appl. No.: 17/923,237

(22) PCT Filed: Dec. 1, 2021
(86) PCT No.: PCT/KR2021/018002

§ 371 Date: Nov. 4, 2022

(30) Foreign Application Priority Data
Oct. 21, 2021 (KR) 10-2021-0140754

(51) Int. Cl. G06F 40/279; G10H 1/00

(52) U.S. Cl. CPC G06F 40/279; G10H 1/0008; G10H 2210/036; G10H 2210/071; G10H 2210/076

(57) ABSTRACT

The present invention is used for automatically generating a sensitive/emotional keyword that suits a sound source, and a method for generating a keyword for a sound source according to the present invention includes: collecting text data related to a target sound source from one or more websites; extracting one or more waveform patterns from the target sound source; generating music information for the target sound source by using the waveform pattern; determining weights of the text data and the music information according to a genre of the target sound source; and generating a keyword to be tagged to the target sound source by selectively using at least one of the text data and the music information according to the determined weights.

### TECHNICAL FIELD

The present invention relates to a method for generating a keyword for a sound source, and particularly, to a method for automatically generating a sensitive/emotional that suits a sound source.

### BACKGROUND ART

As the use of mobile terminals such as laptops, smartphones, and tablet PCs is expanded, the distribution and use of digital sound sources using them is becoming more active. Through the website that provides sound sources and information on the sound sources, users can search and use the desired sound source or sound source information. However, the sound source information should be secured in advance through a process of making a sound source file into a database or provided through metadata. In particular, the sound source information provided by metadata includes only limited information such as a song name, a singer name, a composer name, a sound source length (play time), and a data size, so utilization of the sound source information is not large. In recent years, a service that automatically recommends a sound source that suits the user's tastes has been provided. A terminal or a server that provide the service utilizes a list of preferred music preregistered by a user, a preferred genre, a preferred singer, etc., in order to identify user's tastes. However, provided is no service that recommends a sound source that is suitable for user's emotional state or health state. A process is required, which generates and tags a sensitive or emotional keyword suitable for the sound source, and classifies the sound sources according to the tagged keyword in order to recommend the sound source suitable for a user's psychological or health state.

### DISCLOSURE

### Technical Problem

The present invention is contrived by considering the above point, and has been made in an effort to provide a method for automatically generating and tagging a sensitive or emotional keyword that suits a sound source.

Technical objects to be achieved by the present invention are not limited to the aforementioned technical objects, and other technical objects not described above may be evidently understood by a person having ordinary skill in the art to which the present invention pertains from the following description.

### Technical Solution

A method for generating a keyword for a sound source according to an embodiment of the present invention includes: collecting text data related to a target sound source from one or more websites; extracting one or more waveform patterns from the target sound source; generating music information for the target sound source by using the waveform pattern; determining weights of the text data and the music information according to a genre of the target sound source; and generating a keyword to be tagged to the target sound source by selectively using at least one of the text data and the music information according to the determined weights.

In the extracting of one or more waveform patterns from the target sound source, two or more waveform patterns which are split at a predetermined interval are extracted by using sound length information included in the target sound source.

In the extracting of one or more waveform patterns from the target sound source, intervals and sizes of peaks are detected in the waveform pattern, and the music information is generated by using the intervals and the sizes of the peaks. In this case, at least one of a tempo, beats per minute (BPM), a rhythm, and a genre of the target sound source is determined based on peaks which are larger than a reference value among the peaks included in the waveform patterns, and the music information is generated to include values representing the tempo, the beats per minute (BPM), the rhythm, and the genre which are determined.

In the determining of the weights of the text data and the music information according to the genre of the target sound source, the weights of the text data and the music information are determined according to a genre represented by metadata of the target sound source or a genre and a speed represented by the music information.

In the generating of the keyword to be tagged to the target sound source by selectively using at least one of the text data and the music information according to the determined weights, a keyword corresponding to the target sound source is generated by using the text data when the weight of the text data is equal to or larger than the weight of the music information, and the keyword to be tagged to the target sound source is generated by using the music information when the weight of the text data is smaller than the weight of the music information.

The generating of the keyword to be tagged to the target sound source by selectively using at least one of the text data and the music information according to the determined weights may include extracting words related to emotions or sensitivity among the words included in the text data when the weight of the text data is equal to or larger than the weight of the music information, determining a priority of the extracted words according to the number of repeated times in the text data, determining each of similarities between an existing keyword already tagged to the target sound source and the extracted words, and selecting one of the extracted words as the keyword to be tagged to the target sound source according to the priority and the similarity.

The generating of the keyword to be tagged to the target sound source by selectively using at least one of the text data and the music information according to the determined weights may include searching another sound source having the values most similar to the values included in the music information when the weight of the text data is smaller than the weight of the music information, extracting the words related to the emotions or sensitivity among the words already tagged to the searched sound source, determining each of the similarities between the existing keyword already tagged to the target sound source and the extracted words, and selecting one of the extracted words as the keyword to be tagged to the target sound source according to the similarity.

The generating of the keyword to be tagged to the target sound source by selectively using at least one of the text data and the music information according to the determined weights may include extracting the words the emotions or sensitivity among the words included in the text data and the words searched by using the music information, determining the priority of the extracted words according to the determined weights, determining each of the similarities between the existing keyword already tagged to the target sound source and the extracted words, and selecting one of the extracted words as the keyword to be tagged to the target sound source according to the priority and the similarity.

A method for generating a keyword for a sound source according to another embodiment of the present invention includes: collecting text data related to a target sound source from one or more websites; extracting one or more waveform patterns from the target sound source; generating music information for the target sound source by using the waveform pattern; determining weights of the text data and the music information according to a play history of a user; and generating a keyword to be tagged to the target sound source by selectively using at least one of the text data and the music information according to the determined weights.

### Advantageous Effects

The method for generating a keyword for a sound source according to the present invention can automatically generate a sensitive/emotional keyword suitable for a sound source by using text data and a waveform pattern related to the sound source. Therefore, a user can easily search for a sound source suitable for his/her own psychological state or health state by using a sensitive/emotional keyword tagged to the sound source, and may receive a service that automatically recommends a sound source suitable for a user's state.

### DESCRIPTION OF DRAWINGS

FIG. 1 is a diagram illustrating an apparatus for generating a keyword for a sound source according to the present invention.

FIG. 2 is a diagram illustrating a method for generating a keyword for a sound source according to a first embodiment of the present invention.

FIG. 3 is a diagram illustrating one example of a waveform pattern.

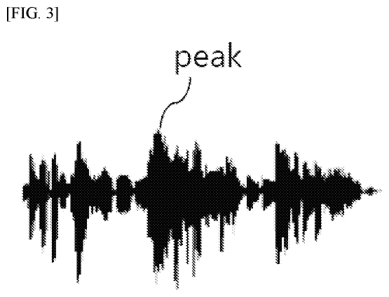

FIG. 4 is a diagram specifically illustrating one example of a step (S150) of generating the keyword of FIG. 2.

FIG. 5 is a diagram specifically illustrating another example of the step (S150) of generating the keyword of FIG. 2.

FIG. 6 is a diagram illustrating a method for generating a keyword for a sound source according to a second embodiment of the present invention.

### MODES FOR THE INVENTION

Hereinafter, embodiments disclosed in this specification will be described in detail with reference to the accompanying figures and the same or similar components are denoted by the same reference numerals regardless of a sign of the figure, and duplicated description thereof will be omitted. Suffixes “module” and “unit” for components used in the following description are given or mixed in consideration of easy preparation of the present disclosure only and do not have their own distinguished meanings or roles. Further, in describing the embodiment disclosed in this specification, a detailed description of related known technologies will be omitted if it is determined that the detailed description makes the gist of the embodiment disclosed in this specification unclear. Further, it is to be understood that the accompanying figures are just used for easily understanding the embodiments disclosed in this specification and a technical spirit disclosed in this specification is not limited by the accompanying figures and all changes, equivalents, or substitutes included in the spirit and the technical scope of the present invention are included.

Hereinafter, an apparatus and a method for generating a keyword for a sound source (music) according to the present invention will be described in detail with reference to the accompanying drawings.

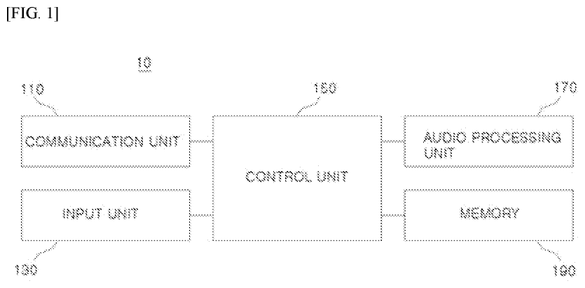

FIG. 1 is a diagram illustrating one example of an apparatus 10 for generating a keyword for a sound source according to the present invention. As illustrated in FIG. 1, the apparatus 10 for generating a keyword for a sound source according to the present invention includes a communication unit 110, an input unit 130, a control unit 150, an audio processing unit 170, and a memory 190.

The communication unit 110 may include one or more modules that enable communication with at least one of a portable terminal, a wireless communication system, and a server by using a wireless communication network or a wired communication network. To this end, the communication unit 110 may include at least one of a mobile communication module, a wireless Internet module, a short-range communication module, and a wired communication module.

The input unit 130 may include a biosignal input unit for inputting a biosignal of a user, an audio input unit for inputting an audio signal, and a user input unit for receiving information from the user. The biosignal input unit measures a heart rate variability (HRV) based on a heart rate received from a wearable device and provides the measured HRV to the control unit 150. The user input unit is used for receiving information from the user, and when the information is input through the user input unit, the control unit 150 may control an operation of the keyword generating apparatus 10 of the present invention in response to the input information. Such a user input unit 150 may include a mechanical input means and a touch type input means.

The audio processing unit 170 is used for processing the audio signal, and may extract the waveform pattern from the sound source and tag information or a keyword related to the sound source to the relevant sound source.

The memory 190 may store multiple application programs or applications driven by a keyword generating apparatus 10, various data, and commands in addition to the sound source and metadata. In addition, the memory 190 may store waveform patterns extracted from the audio processing unit 170 and the keywords tagged to the sound source.

The controller 150 controls an overall operation of the keyword generating apparatus 10. The control unit 150 processes a signal, data, information, and the like input or output through the components or drives the application program stored in the memory 190 to provide or process information or a function appropriate for the user. For example, the control unit 150 accesses a website using the communication unit 110 to collect text data associated with a target sound source, and generate music information showing physical properties and acoustic properties of the target sound source by using the waveform patterns extracted from the audio processing unit 170. In addition, the control unit 150 may automatically generate a sensitive or emotional keyword suitable for the target sound source by using the collected text data and the generated music information.

In addition, the control unit 150 may digitize a stress of the user by using a difference between a heart rate variability value of the user for a predetermined time (e.g., 50 seconds) from a play start of the sound source and a heart rate variability value for a predetermined time (e.g., 50 seconds) after the end of the play. In addition, the control unit 150 may determine a health state and a psychological state of the user by using the digitized stress value, and generate a list of sound sources suitable for a state of the user based on the keyword tagged to the sound source. For example, when the control unit determines that the user is in an anxious or excited state, the control unit 150 may generate a list of sound sources tagged to keywords (e.g., relaxed, stable, calm, gentle, etc.) related to ‘psychological stability’, and provide the generated list to the user. As such, the keyword generating apparatus 10 of the present invention may generate the list of the sound source based on the keyword and may be used as an apparatus for recommending the sound source to the user.

A method for generating a keyword for a sound source using the keyword generating apparatus 10 for the sound source according to the present invention is described below.

### First Embodiment

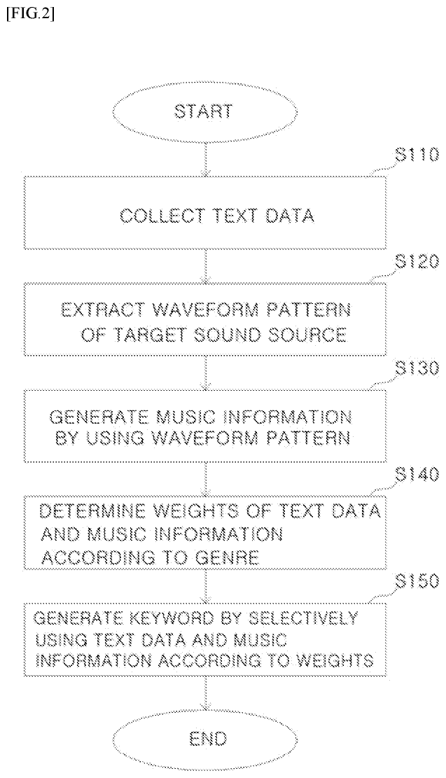

FIG. 2 is a diagram illustrating a method for generating a keyword for a sound source according to a first embodiment of the present invention.

First, the control unit 150 collects text data related to the target sound source from one or more websites using the communication unit 110 (S110). Here, the website may be a website that provides the sound source and additional information (lyrics, a score, a music recorder, etc.) or a website that shares discussions or comments from users about singers or sound sources.

The control unit 150 filters the collected text data, and at this time, excludes remainders other than a word showing acoustic properties such as a tempo, betas per minute (BPM), a rhythm, etc., a word related to a genre, a word of a sensitive or emotional expression, etc. In addition, the control unit 150 stores the filtered text data in the memory 190.

In addition, the control unit 150 extracts two or more waveform patterns from the target sound source using the audio processing unit 170, but preferably extracts 4 to 6 waveform patterns (S120). In this case, the control unit 150 may extract two or more waveform patterns which are split at a predetermined interval by using sound source length information included in metadata of the target sound source. In other words, the control unit 150 splits the target sound source into two or more regions by using the sound source length information included in the target sound source and extracts waveform patterns having predetermined lengths at specific locations of the split regions, respectively. For example, the control unit 150 may extract each waveform pattern having a length of 10 seconds at an intermediate point of each of the split regions. A reason for extracting two or more waveform patterns at a predetermined interval is to more accurately identify the physical properties and the acoustic properties of the target sound source.

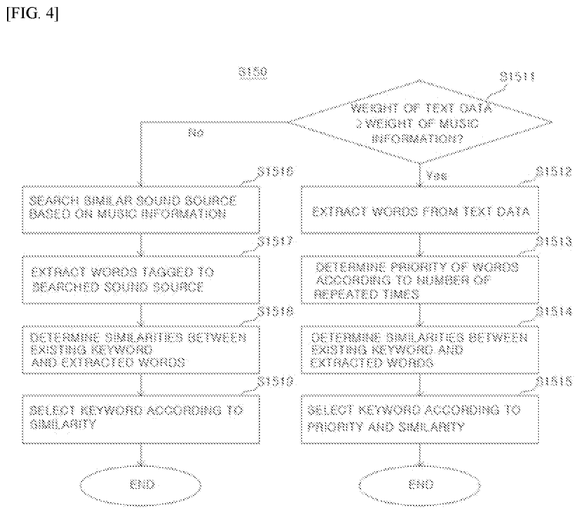

Subsequently, the control unit 150 generates music information for the target sound source by using the extracted waveform patterns (S130), and stores the generated music information in the memory 190. In order to generate the music information, the control unit 150 detects intervals and sizes of peaks having a large amplitude in the waveform patterns as illustrated in FIG. 4, and generates the music information by using the intervals and the sizes of the peaks. In this case, the control unit 150 may determine at least one of the tempo, the beats per minute (BPM), the rhythm, and the genre of the target sound source based on peaks which are larger than a reference value among the peaks included in the waveform patterns, and generates the music information to include values representing the tempo, the beats per minute (BPM), the rhythm, and the genre.

More specifically, the tempo and the BPM may be determined based on peaks which are regularly repeated for a predetermined time, and the rhythm may be determined based on the strengths (size) and the tempo (interval) of the repeated peaks. The genre may be determined based on the tempo, the BPM, and the rhythm of the target sound source. For example, in order to determine the genre of the target sound source, the control unit 150 may compare the tempo, the BPM, and the rhythm of the target sound source and the values stored in the memory 190 by using a Convolutional Recurrent Neural Network (CRNN) which is an artificial intelligent neural network, and determine a genre corresponding to the target sound source based on the stored values. As another method for determining the genre of the target sound source, the control unit 150 may search a sound source having a most similar tempo, BPM, and rhythm to the target sound source, and determine the genre of the sound source having the most similar tempo, BPM, and rhythm as the genre of the target sound source.

The waveform patterns include various signals, and only signals which are repeated periodically are detected among the various signals, and it is preferable to determine at least one of the tempo, the BPM, the rhythm, and the genre of the target source based on the periodic signal. An aperiodic signal is primarily related to a height or a melody of a sound, and it is difficult to identify the physical properties and the acoustic properties of the sound source through the aperiodic signal.

Meanwhile, the physical properties or acoustic properties of the sound source determined through multiple waveform patterns may vary depending on the waveform pattern. That is, when the tempo/BPM/rhythm is changed in one sound source, the physical properties or acoustic properties shown by the waveform patterns may be different. In this case, the control unit 150 may select and use only some of the waveform patterns. For example, only multiple waveform patterns having the similar tempo, BPM, rhythm, etc., may be used, and a minor number of waveform patterns having a non-similar tempo, BPM, rhythm, etc., may be excluded. As another example, a waveform pattern having the fastest tempo, BPM, and rhythm may be selected, and the remaining waveform patterns may be excluded.

Thereafter, the control unit 150 determines weights of the text data and the music information according to the genre of the target sound source (S140). In this case, the control unit 150 determines the weights of the text data and the music information according to the genre represented by the metadata of the target sound source, or determines the weights of the text data and the music information according to the genre and a speed represented by the music information. In particular, when it is determined that information represented by the genre is not included in the metadata, the control unit 150 determines the weights of the text data and the music information based on the genre and the speed represented by the generated music information.

Subsequently, the control unit 1509 generates a keyword to be tagged to the target sound source by selectively using at least one of the text data and the music information according to the determined weights (S150). The method for generating the keyword is described below.

### Keyword Generating Method 1

As illustrated in FIG. 4, first, the control unit 150 compares the weight of the text data and the weight of the music information (S1511), generates a keyword corresponding to the target sound source by using the text data when the weight of the text data is equal to or larger than the weight of the music information, and contrary to this, generates the keyword to be tagged to the target sound source by using the music information when the weight of the text data is smaller than the weight of the music information.

For example, when the weight of the text data is equal to or larger than the weight of the music information, the control unit 150 selects one of the words included in the text data as the keyword to be tagged to the target sound source. When the process is specifically described, when the weight of the text data is equal to or larger than the weight of the music information, the control unit 150 extracts words (e.g., sad, sadness, depression, depressive, joyful, vitality, pleasure, etc.) expressing sensitivity or emotion among the words included in the text data by using a natural language processing engine (e.g., NLP, KoNLPy, or NLPK). In addition, the control unit 150 determines a priority of the words according to the number of repeated times of the words in the text data (S1513). I this case, a word of which number of repeated times is large has a high priority, and contrary to this, a word of which number of repeated times is small has a low priority. Subsequently, the control unit 150 determines each of similarities between an existing keyword already tagged to the target sound source and the words extracted in S1512 by using a cosine similarity estimation scheme (S1514). A method for determining the similarity between the keyword and the word is diversified, and it is preferable to use the cosine similarity estimation scheme which is already well known. Thereafter, the control unit 150 selects one of the words extracted in S1512 according to the priority determined in S1513 and the similarity determined in S1514 as the keyword to be tagged to the target sound source (S1515). For example, the control unit 150 selects one word of which priority and similarity are both high as the keyword of the target sound source.

On the contrary, when the weight of the text data is smaller than the weight of the music information, the control unit 150 searches another sound source having values most similar to the values included in the music information, and selects one of the words already tagged to the searched sound source as the keyword to be tagged to the target sound source. When the process is specifically described, when the weight of the text data is smaller than the weight of the music information, the control unit 150 searches another sound source having values most similar to the values (the values of the tempo, the BPM, the rhythm, and the genre) included in the music information (S1516). In this case, the control unit 150 searches the sound source stored in the memory 190 or searches another sound source stored in the website server. In addition, the control unit 150 extracts the words expressing the sensitivity or emotions among the words already tagged to the sound source searched in S1516 by using the natural language processing engine (S1517). Subsequently, the control unit 150 determines each of similarities between an existing keyword already tagged to the target sound source and the words extracted in S1517 by using a cosine similarity estimation scheme (S1518). Thereafter, the control unit 150 selects one of the words extracted in S1517 according to the similarity determined in S1518 as the keyword to be tagged to the target sound source (S1519). For example, the control unit 150 selects one word of which similarity is high among the extracted words as the keyword of the target sound source

### Keyword Generating Method 2

A second method for generating the keyword according to the weights of the text data and the music information is described below.

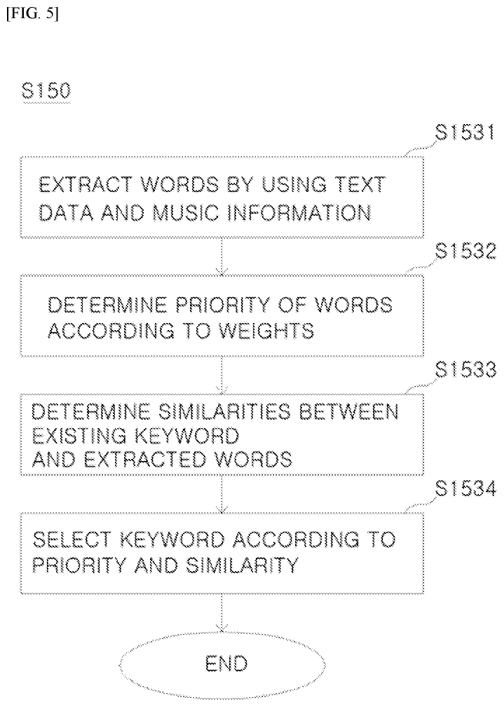

As illustrated in FIG. 5, first, the control unit 150 searches another sound source having values most similar to values included in the music information in the memory 190 or the website or extracts or searches words related to the searched sound source in the memory 190 or the website. Subsequently, he control unit 150 extracts words expressing the sensitivity or emotions among words included in the text data and words obtained by the music information by using the natural language processing engine (S1531).

In addition, the control unit 150 determines a priority of the words extracted in S1531 according to the weight determined in S140 (S1532). In this case, when the weight of the text data is equal to or larger than the weight of the music information, the words included in the text data have a higher priority, and contrary to this, when the weight of the text data is smaller than the weight of the music information, the words obtained by the music information have a higher priority.

Subsequently, the control unit 150 determines each of the similarities between the existing keyword already tagged to the target sound source and the words extracted in S1517 by using the cosine similarity estimation scheme (S1533).

Thereafter, the control unit 150 selects one of the words extracted in S1531 according to the priority determined in S1532 and the similarity determined in S1533 as the keyword to be tagged to the target sound source (S1534). For example, the control unit 150 selects one word of which priority and similarity are both high as the keyword of the target sound source.

### Second Embodiment

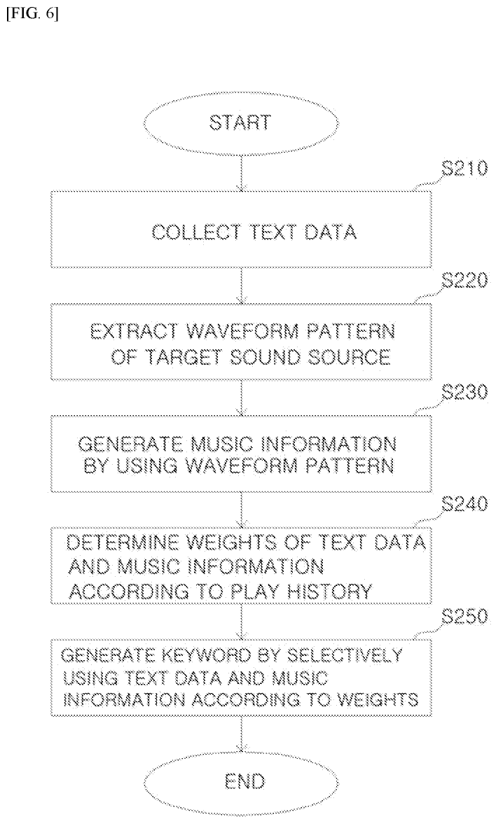

FIG. 6 illustrates a method for generating a keyword for a sound source according to a second embodiment of the present invention.

Similarly to the first embodiment, the control unit 150 collects text data related to the target sound source from one or more websites using the communication unit 110 (S220). Here, the website may be a website that provides the sound source and additional information (lyrics, a score, a music recorder, etc.) or a website that shares discussions or comments from users about singers or sound sources.

The control unit 150 filters the collected text data, and at this time, excludes remainders other than a word showing acoustic properties such as a tempo, betas per minute (BPM), a rhythm, etc., a word related to a genre, a word of a sensitive or emotional expression, etc. In addition, the control unit 150 stores the filtered text data in the memory 190.

In addition, the control unit 150 extracts two or more waveform patterns from the target sound source using the audio processing unit 170, but preferably extracts 4 to 6 waveform patterns (S220).

Subsequently, the control unit 150 generates music information for the target sound source by using the extracted waveform patterns (S230), and stores the generated music information in the memory 190.

Thereafter, the control unit 150 determines weights of the text data and the music information based on a sound soured play history (S240). In this case, the control unit 150 may use the sound source play history of the user stored in the memory 190 or the sound source play history of the user stored in the website server. The control unit 150 may identify a genre preferred by the user based on the sound source play history, and determine the weights of the text data and the music information according to the genre preferred by the user. For example, when the genre preferred by the user is jazz, it is difficult to identify the genre through the waveform pattern for the jazz, so the weight of the text data to which reviews of other users are reflected may be set to be larger. When the genre preferred by the user is a dance music in which the bit is fast, it is easy to identify the genre through the waveform pattern, so the weight of the music information may be set to be larger.

Subsequently, the control unit 1509 generates a keyword to be tagged to the target sound source by selectively using at least one of the text data and the music information according to the determined weights (S250). A specific method for generating the keyword is the same as that of the first embodiment.

Hereinabove, the present invention is illustrated and described in relation to a preferred embodiment for exemplifying a principle of the present invention, but the present invention is not limited to a configuration and an action as it is as illustrated and described as such. Those skilled in the art can well still appreciate that multiple changes and modifications of the present invention can be made without departing from the spirit and the scope of the appended claims.

### INDUSTRIAL APPLICABILITY

The present invention relates to the method for generating a keyword for a sound source, which automatically generates a sensitive/emotional keyword suitable for a sound source by using text data and a waveform pattern related to the sound source, and has an industrial applicability.

1. A method for generating a keyword for a sound source, the method comprising:
collecting text data related to a target sound source from one or more websites;
extracting one or more waveform patterns from the target sound source;
generating music information for the target sound source by using the waveform pattern;
determining weights of the text data and the music information according to a genre of the target sound source; and
generating a keyword to be tagged to the target sound source by selectively using at least one of the text data and the music information according to the determined weights.

2. The method for generating a keyword for a sound source of claim 1, wherein in the extracting of one or more waveform patterns from the target sound source, two or more waveform patterns which are split at a predetermined interval are extracted by using sound length information included in the target sound source.

3. The method for generating a keyword for a sound source of claim 1, wherein in the extracting of one or more waveform patterns from the target sound source, the target sound source is split into two or more regions by using the sound source length information included in the target sound source and the waveform patterns are extracted in the split regions, respectively.

4. The method for generating a keyword for a sound source of claim 1, wherein in the generating of the music information for the target sound source by using the waveform pattern, intervals and sizes of peaks are detected in the waveform pattern, and the music information is generated by using the intervals and the sizes of the peaks.

5. The method for generating a keyword for a sound source of claim 1, wherein in the generating of the music information for the target sound source by using the waveform pattern, at least one of a tempo, beats per minute (BPM), a rhythm, and a genre of the target sound source is determined based on peaks which are larger than a reference value among the peaks included in the waveform patterns, and the music information is generated to include values representing the tempo, the beats per minute (BPM), the rhythm, and the genre which are determined.

6. The method for generating a keyword for a sound source of claim 1, wherein in the generating of the music information for the target sound source by using the waveform pattern, at least one of the tempo, the beats per minute (BPM), the rhythm, and the genre of the target sound source is determined based on a periodic signal detected in the waveform pattern, and the music information is generated to include the values representing the tempo, the beats per minute (BPM), the rhythm, and the genre which are determined.

7. The method for generating a keyword for a sound source of claim 1, wherein in the determining of the weights of the text data and the music information according to the genre of the target sound source, the weights of the text data and the music information are determined according to a genre represented by metadata of the target sound source.

8. The method for generating a keyword for a sound source of claim 1, wherein in the determining of the weights of the text data and the music information according to the genre of the target sound source, the weights of the text data and the music information are determined according to a genre and a speed represented by the music information.

9. The method for generating a keyword for a sound source of claim 1, wherein in the generating of the keyword to be tagged to the target sound source by selectively using at least one of the text data and the music information according to the determined weights, a keyword corresponding to the target sound source is generated by using the text data when the weight of the text data is equal to or larger than the weight of the music information, and the keyword to be tagged to the target sound source is generated by using the music information when the weight of the text data is smaller than the weight of the music information.

10. The method for generating a keyword for a sound source of claim 1, wherein in the generating of the keyword to be tagged to the target sound source by selectively using at least one of the text data and the music information according to the determined weights, when the weight of the text data is equal to or larger than the weight of the music information, one of the words included in the text data is selected as the keyword to be tagged to the target sound source.

11. The method for generating a keyword for a sound source of claim 1, wherein the generating of the keyword to be tagged to the target sound source by selectively using at least one of the text data and the music information according to the determined weights includes
extracting words related to emotions or sensitivity among the words included in the text data when the weight of the text data is equal to or larger than the weight of the music information,
determining a priority of the extracted words according to the number of repeated times in the text data,
determining each of similarities between an existing keyword already tagged to the target sound source and the extracted words, and
selecting one of the extracted words as the keyword to be tagged to the target sound source according to the priority and the similarity.

12. The method for generating a keyword for a sound source of claim 1, wherein in the generating of the keyword to be tagged to the target sound source by selectively using at least one of the text data and the music information according to the determined weights, when the weight of the text data is smaller than the weight of the music information, another sound source having values most similar to the values included in the music information is searched, and one of the words already tagged to the searched sound source is selected as the keyword to be tagged to the target sound source.

13. The method for generating a keyword for a sound source of claim 1, wherein the generating of the keyword to be tagged to the target sound source by selectively using at least one of the text data and the music information according to the determined weights includes
searching another sound source having the values most similar to the values included in the music information when the weight of the text data is smaller than the weight of the music information,
extracting the words related to the emotions or sensitivity among the words already tagged to the searched sound source,
determining each of the similarities between the existing keyword already tagged to the target sound source and the extracted words, and
selecting one of the extracted words as the keyword to be tagged to the target sound source according to the similarity.

14. The method for generating a keyword for a sound source of claim 1, wherein the generating of the keyword to be tagged to the target sound source by selectively using at least one of the text data and the music information according to the determined weights includes
extracting the words the emotions or sensitivity among the words included in the text data and the words searched by using the music information,
determining the priority of the extracted words according to the determined weights,
determining each of the similarities between the existing keyword already tagged to the target sound source and the extracted words, and
selecting one of the extracted words as the keyword to be tagged to the target sound source according to the priority and the similarity.

15. A method for generating a keyword for a sound source, the method comprising:
collecting text data related to a target sound source from one or more websites;
extracting one or more waveform patterns from the target sound source;
generating music information for the target sound source by using the waveform pattern;
determining weights of the text data and the music information according to a play history of a user, and
generating a keyword to be tagged to the target sound source by selectively using at least one of the text data and the music information according to the determined weights.
